(19) United States
(12) Patent Application Publication
(10) Pub. No.: US 2012/0041851 A1
(43) Pub. Date: Feb. 16, 2012

(54) METHOD AND APPARATUS FOR ENHANCED SUPPLY CHAIN MANAGEMENT

(75) Inventor: Thomas Tan, San Jose, CA (US)

(73) Assignee: Verizon Patent and Licensing Inc., Basking Ridge, NJ (US)

(21) Appl. No.: 12/855,935

(22) Filed: Aug. 13, 2010

(51) Int. Cl. G06Q 10/00

(52) U.S. Cl. 705/30; 705/28

(57) ABSTRACT

An approach is provided for facilitating supply chain management based on point-of-sales or device usage data regarding a user device. A supply chain management platform receives an activation signal indicating activation of a device. The supply chain management platform then determines device information relating to the device based on the activation signal. Device information is then stored and subsequently analyzed to generate supply chain management information relating to production of the device.

### BACKGROUND INFORMATION

Supply chain management and high technology forecasting are becoming more dynamic and cost-sensitive due to shorter market life cycles of finished goods. They are an important part of most manufacturers' sales and operations planning (S&OP) process. Manufacturers, distributors and retailers utilize supply and demand forecasting with the help of spreadsheets, proprietary software tools and artificial intelligence to determine product quantities, stocking levels, component inventories and replenishments. An accurate system that is provided the most complete data can help enhance various aspects of an operation, such as enabling cost reductions by minimizing inventory while optimizing stocking levels in response to a sales surge during a promotion. In challenging economic times, supply chain management efficiencies become more important to companies because they contribute directly to the bottom line.

Therefore, there is a need for an approach that provides greater accuracy and efficiency in managing the supply chain.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of facilitating supply chain management based on point-of-sales, activation or device usage data regarding a user device, in accordance with an exemplary embodiment;

FIG. 2 is a diagram of a supply chain management platform configured to enable supply chain management based on point-of-sales, activation or device usage data regarding a user device, in accordance with an exemplary embodiment;

FIG. 3 is a diagram of a wireless communication device configured to enable supply chain management based on point-of-sales, activation or device usage data regarding a user device, in accordance with an exemplary embodiment;

FIGS. 4A and 4B are flowcharts of a process for facilitating supply chain management based on point-of-sales, activation or device usage data regarding a user device, according to various embodiments;

FIGS. 5 and 6 are diagrams of the interaction between a user device, a supply chain management platform and one or more supply chain resources for facilitating supply chain management, according to various embodiments;

FIG. 7 is a diagram of a graphical user interface (GUI) of a wireless communication device configured to facilitate a software update process in response to a supply chain management analysis, according to an exemplary embodiment;

FIG. 8 is a diagram of a computer system that can be used to implement various exemplary embodiments; and

FIG. 9 is a diagram of a chip set that can be used to implement various exemplary embodiments.

### DESCRIPTION OF THE PREFERRED EMBODIMENT

A preferred apparatus, method, and software for facilitating supply chain management based on point-of-sales, activation or device usage data regarding a user device is described. In the following description, for the purposes of explanation, numerous specific details are set forth to provide a thorough understanding of the preferred embodiments of the invention. It is apparent, however, that the preferred embodiments may be practiced without these specific details or with an equivalent arrangement. In other instances, well-known structures and devices are shown in block diagram form to avoid unnecessarily obscuring the preferred embodiments of the invention. Although various exemplary embodiments are described with respect to user devices, it is contemplated that these embodiments have applicability to any electronic product, component, software or combination thereof capable of being supplied by way of a supply chain management system.

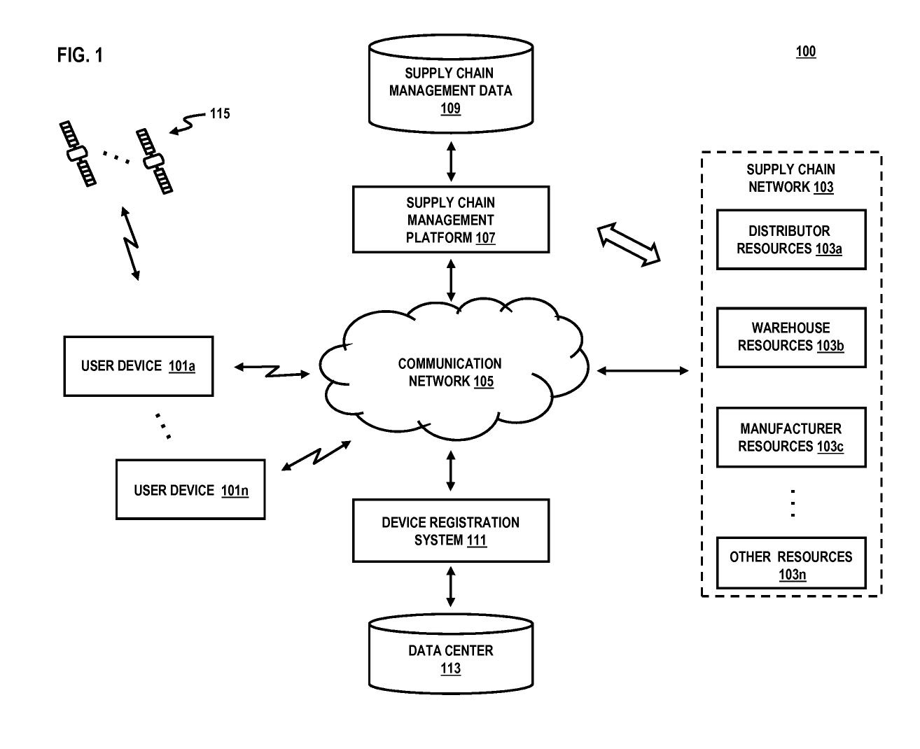

FIG. 1 is a diagram of a system for facilitating supply chain management based on point-of-sales, activation or device usage data regarding a user device, according to an exemplary embodiment. By way of example, the system 100 enables data pertaining to the usage of and/or purchase of user devices 101a-n to be communicated to a supply chain management platform for coordinating various supply chain management (SCM) processes, tasks, activities and goals among various resources of a supply chain. As used herein, the term “supply chain” refers to a system or network of organizations, people, technology, activities, information and other resources involved in moving a product or service from supplier to customer. To actively manage a supply chain for the purpose of achieving business results, supply chain management can be employed and practiced within the organization. According to certain, embodiments, “supply chain management” (SCM) encompasses the planning and management of all activities involved in sourcing and procurement, conversion and all logistics management activities. SCM may also include activities for enabling coordination and collaboration with channel partners, such as suppliers, intermediaries, third-party service providers, and customers. By way of example SCM integrates supply and demand management within and across companies; linking major business functions and business processes such as marketing, sales, product design, finance and information technology within and across companies into a cohesive and high-performing business model. Various methods, standards and practices can be used for facilitating supply chain management and are often performed using various supply chain management tools and technologies.

For companies that rely on supply chain management and forecasting to achieve greater efficiency, such as in the high tech device industry, the effectiveness of the system depends greatly on access to current data regarding the customer and their interaction with the product. It is noted that direct or real-time access to data and feedback from the customer/consumer when a device or product is sold through retail partners, third-party retailers and resellers is limited. Supply chain management efficiencies such as stock replenishing and forecasting are better supported when data surrounding the customer transaction, purchase and fulfillment process is known. This includes data such as the electronic serial number (ESN) of the product as it is sold and used, the make and model of the product, the location of the sale, software release dates and even the color. Unfortunately, distributors and retailers do not provide accurate forecast data, feedback of Point-of-Sale (POS) data or product usage related data that can be used by the manufacturers, warehousers, suppliers and other resources of the supply chain infrastructure. Furthermore, there is no convenient way to link product usage data and/or customer data with production data to facilitate enhanced or optimized supply chain management.

It is recognized that a number of manufacturers place serial numbers or other identifiers on their products so they may identify them once they are sold or placed on the market. The serial number enables manufacturers to classify the make, model, year, release or version of the product so they can develop a bill of materials (BOM). This kind of information is also useful business intelligence for generating forecasts, sales reports, inventory listings and other details necessary for supporting and managing the supply chain. Without direct access to data related to the customer and/or device at the point-of-sale or during the time of activation, manufacturers typically do not have timely knowledge about the actual products sold and used by the consumer. The manufacturers may retrieve data some time later, such as via warranty registration (online and/or mail) or rebate claims, but consumers do not consistently register (if at all). For those that do register, details regarding the device or software serial number, version, make, etc. may be incomplete. Consequently, manufacturers must rely on past experience, historical estimates, self-created spreadsheets, or sophisticated software tools to estimate demand in order to generate a reasonable forecast for production or other reports. These approaches and tools lack the vital real-time data needed to generate the most accurate, up-to-date forecasts or reports.

To address this issue, the system 100 of FIG. 1 provides a mechanism for enabling device information to be readily gathered and stored when a product or device 101a-101n is sold, registered, powered on or subsequently interacted with by the consumer. Furthermore, the system 100 enables the device information to be translated into supply chain management (SCM) information useful for facilitating supply chain management processes and activities. In certain embodiments, “device information” pertains to any data that is sufficient for identifying, classifying, placing, recalling or enabling a particular product, device or details thereof, relative to supporting records for said device. Device information may include, in certain embodiments, serial numbers, product identification tags, model numbers, product make, year of manufacture, product release and version information, batch numbers, product features and specifications, barcodes, manufacturer identifiers, jurisdiction of manufacture information, supplier details and identifiers, reseller or retail data, customer or corporate identifiers, etc. Device information may also include any data pertaining to the customer or the device as obtained during a time of registration or activation with a device registration system 111, including the customer name, address, account information, promotional data, etc. By way of example, a serial number or any other identifier as placed on a device may be linked to production records maintained by various resources that comprise a supply chain network 103, including manufacturers 103c, distributors 103a, retail outlets, warehousers 103b and other resources 103n. The records associated with the serial number may be for recalling additional details about the device that support its manufacture, development, or market placement—i.e., make, model, color, design, customization features, software loads, etc.

In one embodiment, device information for a given user device 101a-n is used by a supply chain management platform 107 to generate or derive supply chain management information. As used herein, “supply chain management information” pertains to any data for performing SCM tasks, procedures and processes for the purpose of optimizing the operational, strategic and business effectiveness of the supply chain network 103. Also, supply chain management (SCM) information refers to any data or intelligence that can be used to inform one or more resources 103a-n of the supply chain network 103 of current device 101a-n usage and its implication to the supply chain or network 103. SCM information may include, in certain embodiments, data concerning: resource network optimization, including the number, location, and size of warehousing, distribution centers, and facilities; operational improvements such as cross docking, direct shipping, and third-party logistics; product life cycle management, so that new and existing products can be optimally integrated into the supply chain and capacity management activities; information technology optimization opportunities; aligning overall organizational strategy with supply strategy; production decisions, including contracting, scheduling, and planning process definition; inventory decisions, including quantity, location, and quality of inventory; benchmarking of all operations against competitors and implementation of best practices throughout the enterprise; daily production and distribution planning, including all nodes in the supply chain; production scheduling for each manufacturing facility in the supply chain (minute-by-minute); demand planning and forecasting, coordinating the demand forecast of all customers and sharing the forecast with all suppliers; sourcing planning, including current inventory and forecast demand, in collaboration with all suppliers; inbound and outbound operations including transportation, inventory receipt and fulfillment; and production operations, including the consumption of materials and flow of finished goods.

By way of example, the supply chain management platform 107 is a network ready system, implemented by way of hardware, software or a combination thereof (e.g., application servers and software modules) for interacting with other elements of the system 100 via communication network 105. The SCM platform 107 can act as an intermediary service between user devices 101a-n in operation by various consumers, a device registration system 111 for enabling the activation/registration of the user devices 101a-n and maintenance of device information in a data center 113, and the supply chain network 103 involved in supplying the user devices 101a-n and making them available for purchase. In addition, the SCM platform 107 executes various functions for generating SCM information (or data) in response to real-time or recently captured device information portrayed or communicated by respective user devices 101a-n. Such SCM data can be stored in a data repository 109, which may be internal or external to the platform 107. In certain embodiments, the SCM platform 107 may also be configured to trigger execution of various SCM actions on behalf of or in connection with the supply chain network 103 in response to device information.

The SCM information can be derived or generated by the SCM platform 107 in the form of one or more reports, or alternatively, as discrete output data points. In other instances, it may comprise a set of data points. Still yet, in other instances the data may be packaged for presentment to a graphical user interface of a computing device, such is by way of a SCM based software application, word processing tool or spreadsheet application. Generally, the SCM information is derived or generated from analysis and/or processing of device information pertaining to the one or more user devices 101a-n as it is received by the SCM platform 107. Once received, the device information can be processed using one or more data models and/or processing schema specifically implemented according to various aspects of supply chain management. While various data models may be employed, exemplary categories or sources for the data models may include, but is not limited to: the Supply Chain Operations Reference (SCOR), Global Supply Chain Forum (GSCF), The American Productivity & Quality Center (APQC) Process Classification Framework^{SM}, extended enterprise management principles, tax efficient supply chain principles and any other strategic, tactical, global and operational approaches.

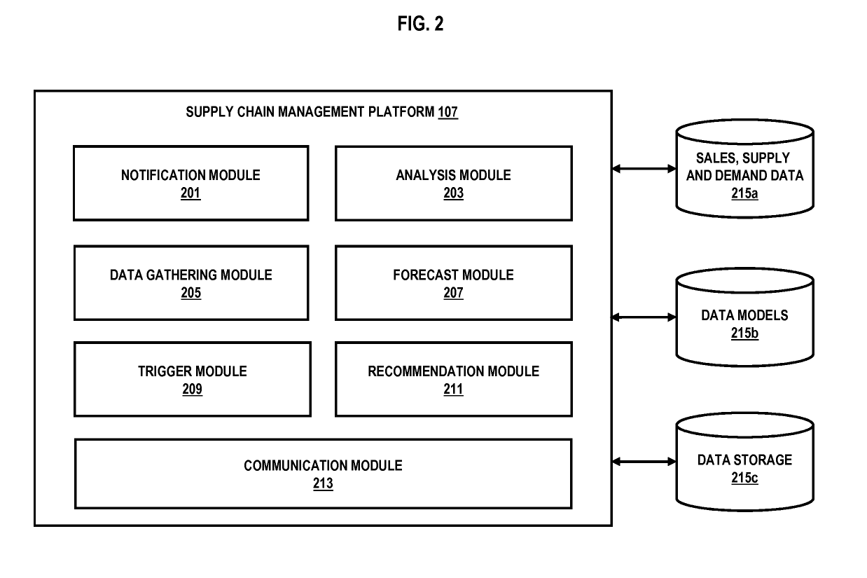

FIG. 2 is a diagram of a supply chain management platform configured to enable supply chain management based on point-of-sales or device usage data regarding a user device, in accordance with an exemplary embodiment. As mentioned, the SCM platform 107 comprises various executable modules for enabling particular processing features, including a notification module 201, an analysis module 203, an data gathering module 205, a forecast module 207, a trigger module 209, a recommendation module 211 and a communication module 213. The notification module 201 receives updates from the data registration system 111 regarding the activation, registration, first-time use or subsequent use of a particular device 101a-n supplied via the supply chain network 103. By way of example, when a consumer purchases a wireless communication device from a retail outlet or other distributor resource 103a associated directly or indirectly with the supply chain network 103, the activation and device configuration process may entail an over-the-air (OTA) activation protocol or other process as administered by the device registration system 111. The device information exchanged during this process is maintained by the device registration system 111 in a data center 113.

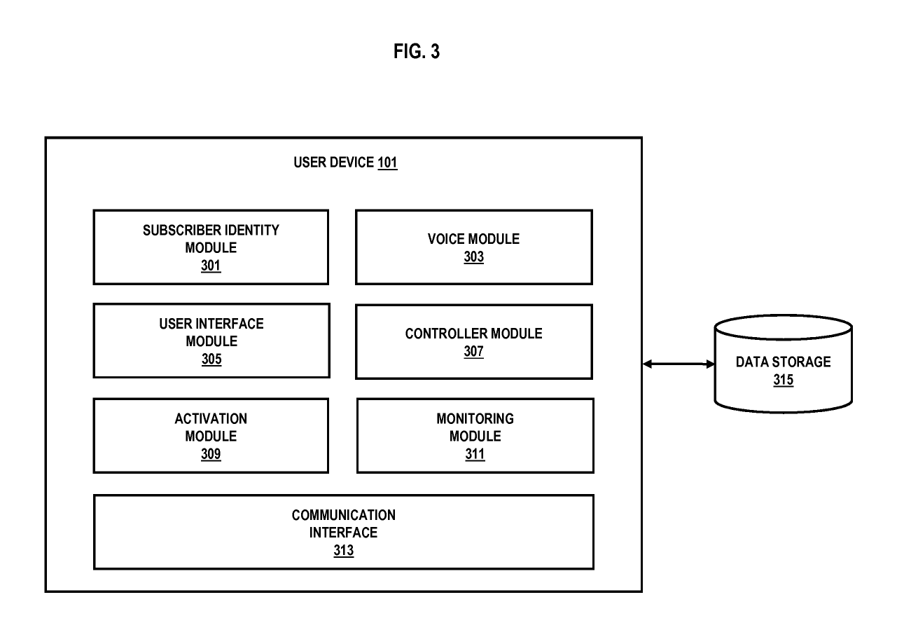

In accordance with an embodiment, a notification message is subsequently sent to the notification module 201 in response to any recently activated, used or registered devices 101a-n. This approach ensures that device registration, activation and usage are accounted for as quickly as possible by the SCM platform 107, such as to enable real-time notification. Alternatively, the notification module 201 may be configured to inquire with the device registration system 111 about registered devices on a periodic basis, such as hourly, daily, weekly, monthly or any other customized frequency. Still yet, in other instances, the notification module 201 may receive notice via the communication network 105 that device information has been communicated or is available at the time of registration, activation or subsequent use directly from the one or more user devices 101a-n. With this approach, the notification is not contingent upon the device registration system 111 and device information can be subsequently gathered directly from the device as opposed to via the data center 113. The examples presented herein may be applied in accordance with any of the above described approaches or a combination thereof. It is noted that the notification process is based on the receipt of information from a device associated with the supply chain network and consequently the SCM platform 107; wherein devices not affiliated with the distributor resources 103a, warehouse resources 103b, manufacture resources 103c, etc. of the network 103 are not reported. Consequently, respective devices associated with the supply chain network 103 are configured to notify accordingly, as discussed later on with respect to FIG. 3.

Once notification of the availability and/or generation of device information occurs, in accordance with one embodiment, the SCM platform 107 retrieves the device information by way of a data gathering module 205 and stores it to a data storage 215c. In addition, the data gathering module 205 parses/extracts information from the device that is deemed useful for generating supply chain info. Determination of the most relevant or useful information is based on one or more data models 215b also maintained by the SCM platform 107. The type of device information identified by the data gathering module 205 may include, in certain embodiments, data indicative of the device model, a unique device identifier, the device purchase location or activation, device make and model, etc. Additional data regarding the device or customer may be further retrieved by the data gathering module 205 by cross referencing the received device information against production records maintained as sales, supply and demand data 215a. By way of example, a serial number identified during activation or use of the product may be linked to data pertaining to its manufacture by a particular manufacturer, factory, etc. The sales, supply and demand data 215a is provided by the various resources 103a-n of the supply chain network 103, and includes information regarding device manufacture, distribution, supply, research and development, sales and marketing, warehousing, etc. It is noted, therefore, that the SCM platform 107 effectively gathers data relevant to all aspects of the supply chain network 103, including those activities of a device before and after its production, activation and use by a consumer.

In accordance with an embodiment, an analysis module 203 operates in connection with the data gathering module 205 for generating and/or deriving supply chain management information based on the gathered device information. By way of example, the analysis module 203 employs the various data models 215b provided by the one or more resources 103a-n of the supply chain network 103, for processing the device information accordingly. This may include, in certain embodiments, comparing the device information against sales, supply and demand data for generating specific supply chain information (e.g., metrics, data points, reports) of interest to the network 103, performing computations against the device information based on SCM principles, factors, and algorithms, etc. In certain instances, the analysis module 203 can be configured to generate data indicative of the current needs or status of the supply chain network 103, such as current inventory levels for specific components involved in the manufacture of the device, current distribution/output levels, current production expenditure vs. revenue, etc. Hence, it is noted that the analysis module 203 generates results indicative of the current strategic, tactical, global and operational competencies of the supply chain network 103. Further, it is noted that these results are informed by and based upon real-time or the most recent device information available. Generally, the results of the analysis performed can be communicated throughout the supply chain network 103, fostering collaborative communication among resources 103a-n.

In accordance with an embodiment, a forecast module 207 also operates in connection with the data gathering module 205 for performing predictive analysis and creating forecasts based on one or more supply chain data models 215b. By way of example, the forecast module 207 analyzes the acquired real-time device information to generate and/or derive a report specifying future inventory, customer fulfillment, value chain, warehousing, material acquisition, personnel and other needs of the supply chain network 103. As another example, the forecast module 207 may analyze historical sales, supply and demand data 215a against the device information provided by the data gathering module 205 for generating metrics demonstrative of future growth, expansion or efficiency needs of the supply chain network 103 or specific resources 103a-n thereof. Generally, the results of the analysis performed can be communicated throughout the supply chain network 103, fostering collaborative communication among resources 103a-n of various strategic, tactical, global and operational actions or needs.

As mentioned above, the supply chain management information rendered by the analysis module 203 and forecast module 207 can be in the form of various data points, reports or metrics. In accordance with an embodiment, the data points, reports or metrics (e.g., the results) can be shared with a trigger module 209, which is configured by the one or more resources 103a-n of the supply chain network 103. The trigger module 209 triggers specific supply chain management actions based on the determined current level, status or needs of the network 103 indicated by the analysis module 203, or the forecasted actions or needs of the network 103 as determined by the forecast module 207. By way of example, if it is determined that increased sales of a product has occurred in a specific geographic area, the trigger module 209 can signal increased device production by a manufacturing resource 103c that operates in that area to meet demand. As another example, the trigger module 209 can signal replenishment of supplies and materials, personnel ramp-up or ramp-down, increased or decreased warehousing, just-in-time (JIT) purchasing or any other SCM needs of the supply chain network 103 based on the analysis results. It is noted that the trigger module 209 can be configured to operate on a threshold basis, wherein a determined level of need, status or opportunity to within a specific threshold (percentage, quantity) enables its execution. Still further, it is noted that the signal generated by the trigger module 209 can in certain instances be a notification signal, while in others, may be a signal for causing a specific operational or machine response within the supply chain network 103 (e.g., automatic supply ordering, shutdown of a machine). The resources 103a-n may configure the trigger module 209 respective to their individual preferences accordingly for the purpose of enhancing the supply chain management of the network 103.

In accordance with an embodiment, a recommendation module 211 is also provided by the SCM platform 107 for suggesting product upgrades, software patches, feature enablement and other opportunities to a consumer of the device 103a-n in response to its activation, registration and/or usage. For example, when it is determined that a particular device has outdated software, the recommendation module 211 may prompt the user of the device to purchase or download can updated version of the software is available. As yet another example, the recommendation module 211 may suggest to the user the download of a software fix for relative to the determined version of software on the device, the purchase of an additional product, a one-time offer based on the consumer's spending habits, etc. The recommendation may be presented in the form of an e-mail, text message or other form of communication. It is noted that the recommendation module 211 supports the customer service, product fulfillment and operational needs of the user as well as the vertical, lateral or up-selling capabilities of the supply chain network 103.

In accordance with an embodiment, network based interaction with the SCM platform 107 is provided by way of a communication module 213. The communication module 213 provides a conduit through which the various resources 103a-n of the supply chain network 103 may interact with the supply chain management platform 107, including the loading of data models 215b, sales, supply and demand data 215a, etc. It is noted that the resources 103a-n may also include specialized tools and software for performing logistics, order fulfillment, warehouse management, etc. The communication module 213 can be appropriately configured to interface with these systems for enabling seamless interaction and retrieval of data models 215b, sales, supply and demand data 215a, key personnel, and other resources vital to supporting the supply chain management effort. Still further, the communication module 213 may operate in connection with the notification module 201 for ensuring proper packaging of data to and from the SCM platform 107, i.e., as device information is retrieved from the data registration system 111 via the communication network 105.

The various elements of system 100 operate in concert to enable and support enhanced supply chain management via supply chain network 103. Furthermore, all of the above described elements of the system 100 are communicable with one another over communication network 105. In system 100, according to certain embodiments, communication network 105 may be one or more of a combination of a data network, service provider network, telephony network, and/or wireless network, configured to handle various communication sessions, voice communications as well as non-voice communications. Communication network 105 may be any suitable wireline and/or wireless network. In the example of a telephony network, communication network 105 may include a circuit-switched network, such as the public switched telephone network (PSTN), an integrated services digital network (ISDN), a private branch exchange (PBX), or other like network.

When configured for wireless communication, communication network 105 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Meanwhile, when configured as a data network, communication network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Still further, the communication network 105 may embody circuit-switched and/or packet-switched networks that include facilities to provide for transport of circuit-switched and/or packet-based communications. It is further contemplated that the communication network 105 includes components and facilities to provide for signaling and/or bearer communications between the various components or facilities of system 100. In this manner, the network 105 may embody or include portions of a signaling system 7 (SS7) network, a Session Initiation Protocol (SIP) network, or other suitable infrastructure to support control and signaling functions. As such, network 105 may be adapted to facilitate the supply chain management enablement services of system 100.

While the various embodiments discussed herein pertain to facilitating supply chain management based on point-of-sales, activation or device usage data regarding a user device, the principles apply to any type of user device through which data may be received or relayed. User devices may include, but is not limited to, mobile devices (e.g., cellular phones, BLUETOOTH-enabled devices, WiFi-enable devices, etc.), a set-top box (STB), a computer 101 (e.g., desktop computer, laptop, web appliance, netbook, etc.) and voice station. Regardless of type, generally, user devices are configured to communicate over the communication network 105 using voice sessions as well as other non-voice sessions, e.g., short messaging service (SMS), enhanced messaging service (EMS), multimedia messaging service (MMS), instant messaging (IM), etc. Also, the devices may convey geographical or spatial information with a constellation of global positioning system (GPS) satellites 115, such as to enable location detection, by way of example. User devices may be any cellular phone, radiophone, satellite phone, smart phone, wireless phone or any other suitable mobile device, such as a personal digital assistant (PDA), pocket personal computer, tablet, customized hardware, etc. More regarding the specific configuration of a user device for enabling the acquisition and presentment of barcode information and/or to support supply chain management within a supply chain network 103 is presented in greater detail in FIG. 3.

FIG. 3 is a diagram of a user device configured to enable supply chain management based on point-of-sales or device usage data regarding a user device, in accordance with an exemplary embodiment. The user device 101, which may be a mobile phone, mobile computer or other wireless communication device includes an optional subscriber identity module 301 that is configured to support removable SIM cards. The SIM card may store a unique serial number, internationally unique number of the mobile user (IMSI), security authentication and ciphering information, temporary information related to the local network, a list of the services the user has access to and two passwords (PIN for usual use and PUK for unlocking). It is noted that the above described data provided by the SIM card is useful device information capable of being shared or retrieved by the SCM platform 107.

In accordance with an embodiment, the device 101 also includes a voice module 303 configured to establish a voice-based call. Such voice-based calls can be traditional plain-old-telephone service (POTS) calls or packetized voice calls (e.g., VoIP). These communication sessions can occur concurrently during a call. It is noted that these communication sessions can be established over a circuit-switched network, a packet-switch network or a combination thereof. Thus, communication interface 313 can be appropriately configured depending on the transport systems and/or communication network 105 elements involved. In one embodiment, device 101 can also utilize data storage 315 to store various information in support of the various modules 301-313.

In accordance with an embodiment, a user interface module 305 enables presentment of data to a graphical user interface of the user device 101. Various software applications operable by the user device may feature APIs or other function calls corresponding to the user interface module 305 for enabling graphical elements to be displayed by the device. It is noted that in some instances multiple communication interfaces may be utilized depending on the type of user device 101 involved. Moreover, the user device 101 employs the user interface module 305 to enable control by the user of the device 101 of various communication features during a session. Additionally, a controller module 307 is configured to regulate the communication processes between the various modules. For example, the controller module 307 generates the appropriate signals to control the communication interface 313 for transmission over the communication network 105 to which a carrier network may be implemented. The carrier network, such as in the case of the user device being a mobile phone, may be configured by way of the communication network 105 appropriately to enable radio frequency (RF) communication.

When a device is being registered or activated for first time use, an activation module 309 is enabled for permitting the operation of the user device, in accordance with an embodiment. Activation is permitted based on activation settings for that particular device, as configured by the device manufacturer 103c or other resource 103n of the supply chain network 103. In addition, the activation module 309 is configured to send a notification of its activation and/or registration, along with pertinent device information, to a device registration system 111 or to the supply chain management platform 107 directly. A monitoring module 311 can also be configured for monitoring various activities of the device, including first time usage and subsequent usage. The monitoring module 311 can also communicate with the SCM platform 107 for exchanging device information that relates the current state of the device or status of various software utilities on the device. The device information as presented through monitoring of the device, such as on a persistent or periodic basis, may in turn be used to generate recommendations for software updates, fixes and other products and features by the SCM platform 107.

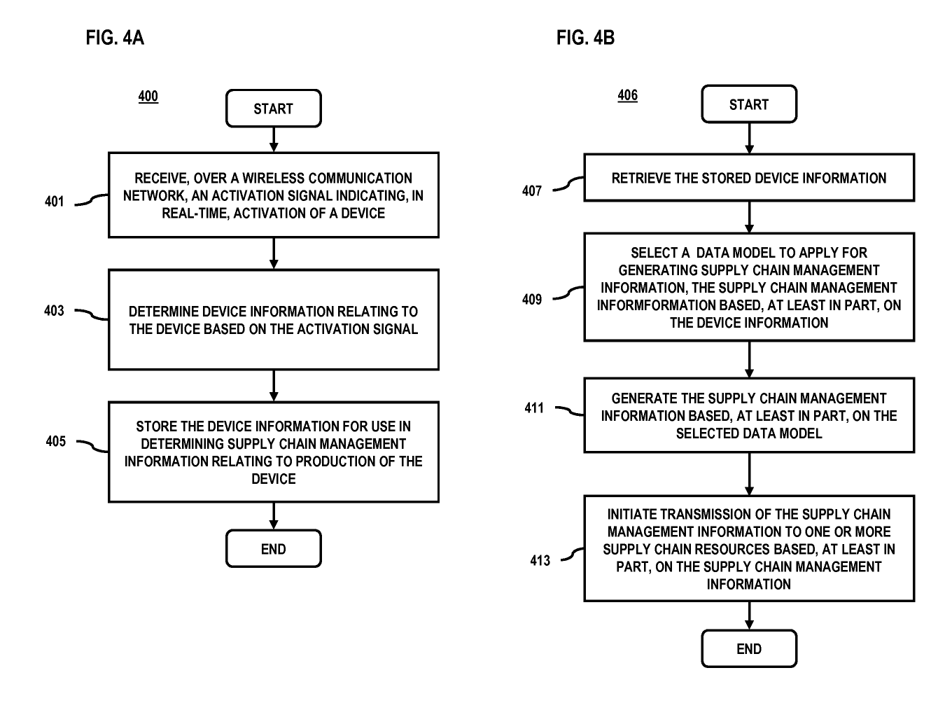

FIGS. 4A and 4B are flowcharts of a process for facilitating supply chain management based on point-of-sales, activation or device usage data regarding a user device, according to various embodiments. Process 400 of FIG. 4A pertains to the execution of the SCM platform 107 for gathering and subsequently storing device information. In step 401 of process 400, the SCM platform 107 receives an activation signal indicating in real-time, activation of a device. Next, the SCM platform 107, per step 403, then determines device information relating to the device based on the activation signal. This corresponds to the process of identifying the device information that is most suitable for conversion to supply chain management information. In step 405, the device information as gathered is stored to data storage 215c of the SCM platform 107. By way of example, this device information is that which relates to production of the device and is suitable for generating supply chain management information.

Process 406 of FIG. 4B pertains to the execution of the SCM platform 107 for generating supply chain management information relating to production of the device 101a-n. In step 407, the device information by the SCM platform is retrieved. In step 409, the SCM platform 107 then selects a data model to apply with respect to the device information. As mentioned previously, the data model is selected based, at least in part, on the device information, i.e., the type of device information available. In addition, the data model applied may also be based on a particular supply chain management information need of the supply chain network 103, wherein the SCM platform 107 is configured to run certain types of reports or render certain information by direct request of the one or more resources 103a-n.

In step 411, the SCM platform 107 generates the supply chain management information based, at least in part, on the data model(s) selected. In step 413, the supply chain management information as generated is then made available to several of the resources 103a-n of the supply chain network 103. Transmission of the supply chain management information can be limited to only those resources that specifically request access to the data, or alternatively, can be sent based on characteristics of the device information utilized to generate the supply chain management information. Alternatively, the supply chain management information can be transmitted to all of the resources 103a-n of the supply chain network 103, where it is presented in the form of data points, metrics or reports that are customized to the particular function of the resource in question. It is noted also that the SCM platform 107 can present the supply chain management information to the one or more resources 103a-n in the form of a real-time dashboard, interactive charts and graphs, key performance indicators (KPIs) and other virtual performance display and monitoring tools.

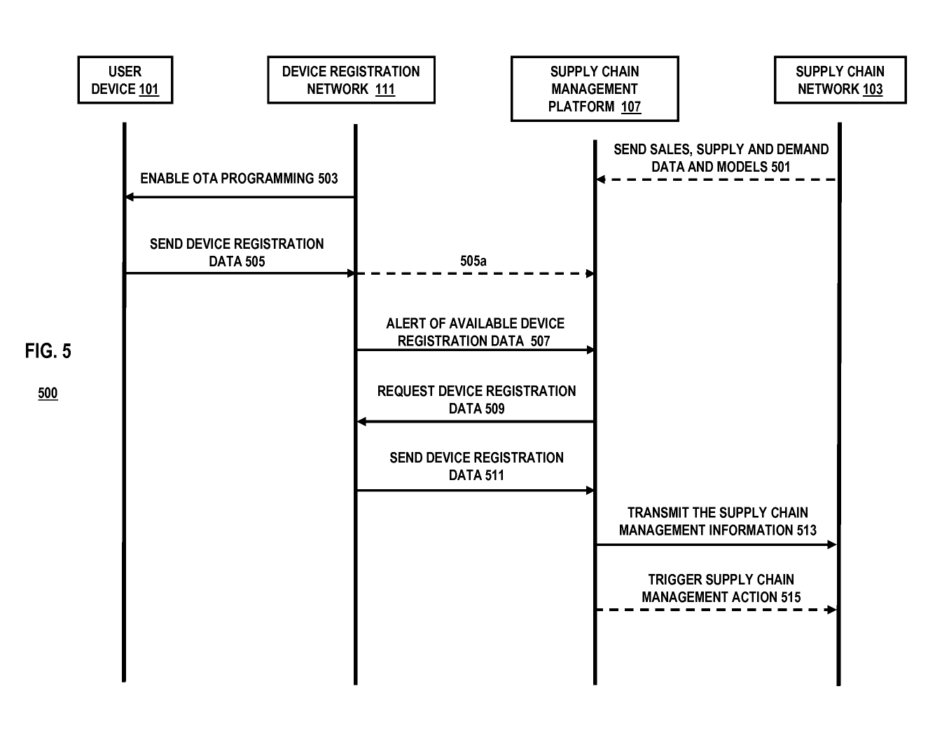

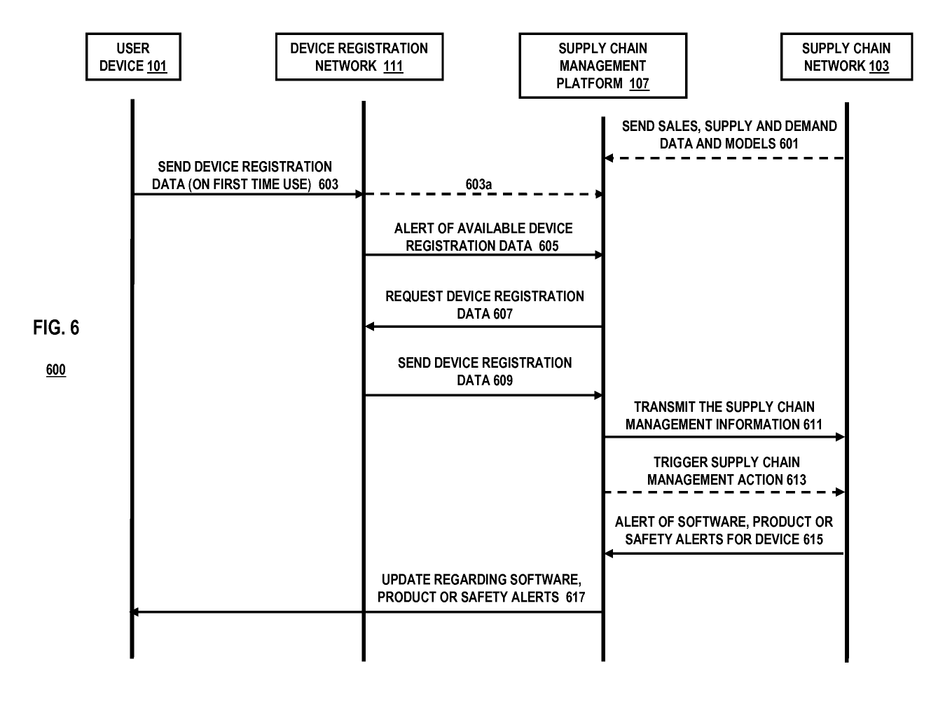

FIGS. 5 and 6 are diagrams of the interaction between a user device, a supply chain management platform and one or more supply chain resources for facilitating supply chain management, according to various embodiments. By way of example, the process 500 suggests an exemplary means of communication of system 100 for enabling and supporting enhanced supply chain management among resources 103a-n of the supply chain network 103. In step 501, the supply chain management (SCM) platform 107 is equipped by the various resources 103a-n of the supply chain network 103 with the necessary data it relies upon to support the supply chain management effort. This can include the sales, supply and demand data 215a as well as the data models 215b. Other relevant data regarding the production of user devices may also be optionally provided, including current factory conditions, current production schedules, machine maintenance or downtime, etc. In this case, the SCM platform 107 may also account for the current operating and physical conditions of the various resources as it pertains to the generation of useful supply chain management information.

In step 503, the device activation and registration process is engaged by a device registration system 111 through execution of over-the-air (OTA) programming. In general, this process involves wireless transmission of activation or feature enablement firmware or software to the user device over the communication network 105. To proceed with activation or enablement, the user responds to specific commands presented by the device registration system 111 to the user device (e.g., a text message response process, place a phone call to the device registration system 111). This interaction with the device registration system results in the exchange of device registration data as requested by the device registration system 111 (step 505). In certain instances step 505 is further carried out as step 505a, where the device registration data is sent directly to the supply chain management platform 107.

In step 507, once the device registration data is received by the device registration network 507, it is processed accordingly and an alert is sent to the SCM platform 107. The alert indicates to the SCM platform 107 the availability of the device registration data. In response to this action, in step 507 the SCM platform 107 requests, as in step 509, access to the registration data, which it can utilize to ascertain relevant device information. The device registration network 111 then sends the device registration data to the SCM platform in step 511, therefore enabling the SCM platform 107 to retrieve then extract relevant device information accordingly. It is noted that the retrieval process can be performed periodically rather than for every device registration that occurs.

Once received, the SCM platform 107 processes the device information in the manner described above with respect to FIGS. 2 and 4A and 4B. This can include analyzing the data, performing computations against various data models, generating forecasts, etc, for the purpose of generating and/or deriving from the device information useful supply chain management information for execution by the supply chain network 103. In step 513, the supply chain management information as rendered by the SCM platform 107 is then transmitted to the one or more resources of the supply chain network 103. In an optional step 515, a supply chain management action relating to one or more resources of the supply chain network 103 may be triggered for execution accordingly, based on the supply chain management information.

In accordance with an embodiment, the process 600 of FIG. 6 presents an exemplary means of facilitating communication with the various user devices 101 supplied by or associated with the supply chain network 103. As with the process 500 of FIG. 5, in step 601, sales, supply and demand data and models are provided to the platform 107 by the supply chain network 103. In step 603, the user device 101 transmits device registration data during its first time of use and/or activation (e.g., at the retail outlet from which it is sold). Steps 603a-613 are then performed in a similar manner as steps 505a-515 of process 500. Once the supply chain management information 611 is received, the supply chain network 103 may identify an opportunity or need respective to the device corresponding to the device information. Resultantly, in step 615, the supply chain network 103 alerts the SCM platform 107 of any software, products or safety alerts associated with or available for acquisition by the user device 101. The SCM platform 107 then sends an alert to the user device of an update regarding the software, product or safety alert to the user device 101, such as in the form of a text message or e-mail communication, corresponding to step 617.

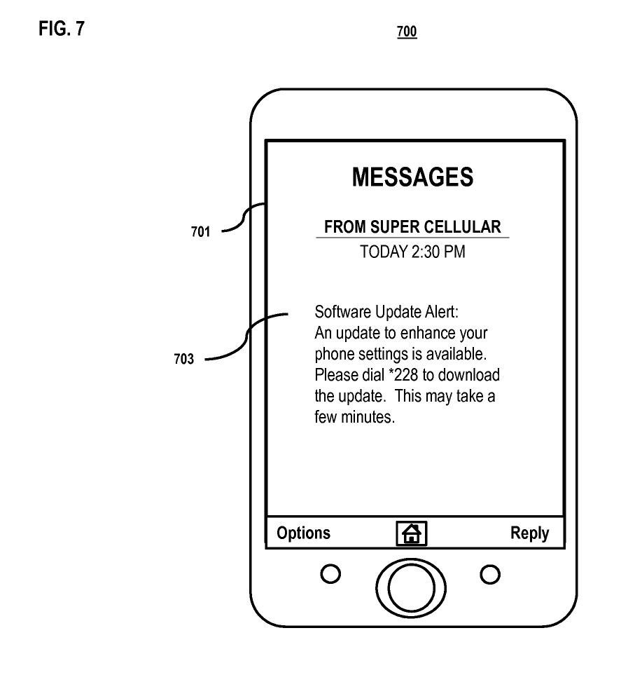

FIG. 7 is a diagram of a graphical user interface (GUI) of a wireless communication device configured to facilitate a software update process in response to a supply chain management analysis, according to an exemplary embodiment. By way of example, when the SCM platform 107 sends an alert message (or notification) to the user device 700 (e.g., user device 101 of system 100) of an available update as in step 617, the alert message is rendered to the device's graphical user interface 701. A message area or box 703 is provided for this message, which provides instructions for the user of the device to follow for enabling activation, download, procurement or execution of the update. Any additional device information generated by the user device 101 as the update is executed is also provided to the SCM platform 107. In this way, persistent monitoring of data produced during customer side and production side interaction with a given user device is maintained by the SCM platform 107.

The above described processes, in certain embodiments, advantageously provide an efficient, convenient, and secure approach for facilitating supply chain management throughout a supply chain network 103 based on real-time customer/consumer data. Convenient, direct and instant access to data on the consumer and production sides of a supply chain enables optimized management of the supply network 103. In addition, the described processes, in certain embodiments, provide a convenient platform from which to enable up-selling, lateral selling, vertical integration and selling and one-time offers to be presented to consumers based on supply chain management intelligence. Still further, the exemplary system and techniques described herein provide a means for accounting for software or device updates, safety alerts or product offers and recommendations to be readily performed.

It is noted that various systems to manage and improve a supply chain network 103 may be utilized among the differing resources 103a-n, including but not limited to Order Management Systems, Warehouse Management Systems, Transportation Management Systems, Inventory Management Systems, Replenishment Systems, and the like. The SCM platform 107 may be advantageously configured to operate as an intermediary interface between these disparate systems; thereby enabling the seamless unification of data and resources vital for supporting enhanced supply chain management.

The processes described herein for providing enhanced supply chain management through a device user interface may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

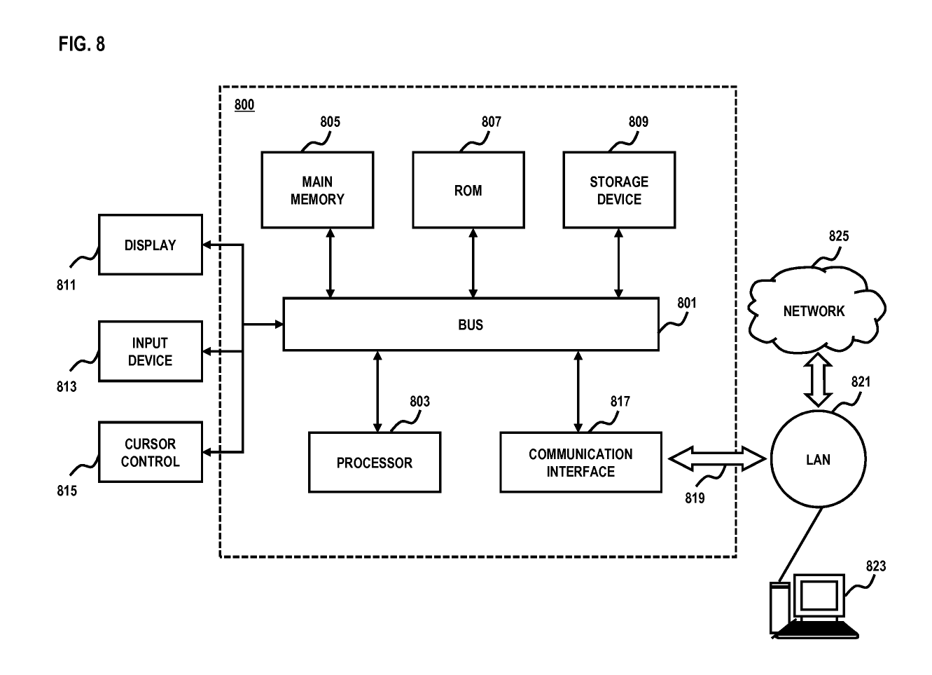

FIG. 8 illustrates computing hardware (e.g., computer system) upon which these embodiments can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions (computer program code) to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to certain embodiments, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

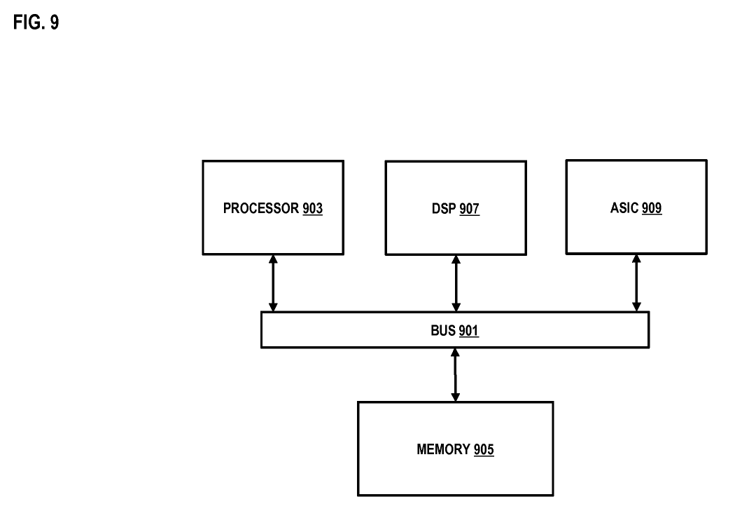

FIG. 9 illustrates a chip set 900 upon which an embodiment of the invention may be implemented. Chip set 900 is programmed to present a slideshow as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of FIGS. 4-6.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving, over a wireless communication network, an activation signal indicating, in real-time, activation of a device;
determining device information relating to the device based on the activation signal; and
storing the device information for use in determining supply chain management information relating to production of the device.

2. A method according to claim 1, wherein the supply chain management information specifies data relating to product quantities, stocking levels, component inventories, replenishments, production, customer fulfillment or a combination thereof.

3. A method according to claim 1, wherein the device information specifies a serial number uniquely identifying the device with respect to make, model, and year; bill of material specifying components of the device; or a combination thereof; and
wherein the device includes a cellular phone, and the activation signal is associated with activating the cellular phone for operation over the wireless communication network.

4. A method according to claim 1, further comprising:
tracking statistical information for the device, wherein the statistical information correspond to usage or failure of the device.

5. A method according to claim 1, wherein the activation signal originates from a transponder affixed to the device, the transponder being configured to be powered by a power supply of the device; and wherein the device includes a vehicle, an appliance, a computer, or a game console.

6. A method according to claim 1, further comprising:
initiating transmission of the device information to a supply chain management platform configured to generate the supply chain management information.

7. A method according to claim 1, further comprising:
determining location information for the device during the activation of the device, wherein supply chain management information is further determined based on the location information.

8. A method according to claim 1, further comprising:
selecting a data model based on the device information;
generating the supply chain management information based on the selected data model; and
initiating transmission of the supply chain management information to one or more supply chain resources based on the supply chain management information.

9. A method according to claim 8, wherein the data model corresponds to current, historical or expected product quantities, stocking levels, component inventories, replenishments, or a combination thereof; and the data model is based on information provided by one or more supply chain resources.

10. An apparatus comprising:
at least one processor; and
at least one memory including computer program code for one or more programs,
the at least one memory and the computer program code configured to, with the at least one processor, cause the apparatus to perform at least the following,
receiving, over a wireless communication network, an activation signal indicating, in real-time, activation of a device,
determining device information relating to the device based on the activation signal, and
storing the device information for use in determining supply chain management information relating to production of the device.

11. An apparatus according to claim 10, wherein the supply chain management information specifies data relating to product quantities, stocking levels, component inventories, replenishments, production, customer fulfillment or a combination thereof.

12. An apparatus according to claim 10, wherein the device information specifies a serial number uniquely identifying the device with respect to make, model, and year; bill of material specifying components of the device; or a combination thereof; and
wherein the device includes a cellular phone, and the activation signal is associated with activating the cellular phone for operation over the wireless communication network.

13. An apparatus according to claim 10, wherein the apparatus is further caused to:
track statistical information for the device, wherein the statistical information corresponds to usage or failure of the device.

14. An apparatus according to claim 10, wherein the activation signal originates from a transponder affixed to the device, the transponder being configured to be powered by a power supply of the device; and wherein the device includes a vehicle, an appliance, a computer, or a game console.

15. An apparatus according to claim 10, wherein the apparatus is further caused to:
initiate transmission of the device information to a supply chain management platform configured to generate the supply chain management information.

16. An apparatus according to claim 10, wherein the apparatus is further caused to:
determine location information for the device during the activation of the device, wherein supply chain management information is further determined based on the location information.

17. An apparatus according to claim 10, wherein the apparatus is further caused to:
select a data model based on the device information;
generate the supply chain management information based on the selected data model; and
initiate transmission of the supply chain management information to one or more supply chain resources based on the supply chain management information.

18. An apparatus according to claim 17, wherein the data model corresponds to current, historical or expected product quantities, stocking levels, component inventories, replenishments, or a combination thereof; and the data model is based on information provided by one or more supply chain resources.

19. An apparatus comprising:
a processor configured to generate an activation signal indicating, in real-time, activation of a device coupled to the apparatus; and
a transponder coupled to the processor and configured to transmit the activation signal over a wireless communication network to a product forecasting platform,
wherein the processor is further configured to receive monitoring information about the device, the monitoring information being periodically reported to the product forecasting platform.

20. An apparatus according to claim 19, wherein the product forecasting platform is configured to generate, based on the activation signal, supply chain management information that includes data relating to product quantities, stocking levels, component inventories, replenishments, production, customer fulfillment or a combination thereof.
